(19) United States
(12) Patent Application Publication
(10) Pub. No.: US 2018/0139642 A1
(43) Pub. Date: May 17, 2018

(54) LOCAL CONGESTION DETERMINATION METHOD AND CONGESTION CONTROL DEVICE FOR MOBILE COMMUNICATION

(71) Applicant: NEC Corporation, Tokyo (JP)

(72) Inventor: Keisuke YOSHIDA, Tokyo (JP)

(73) Assignee: NEC Corporation, Tokyo (JP)

(21) Appl. No.: 15/578,610

(22) PCT Filed: Jun. 1, 2016
(86) PCT No.: PCT/JP2016/066268

§ 371 Date: Nov. 30, 2017

(30) Foreign Application Priority Data
Jun. 4, 2015 (JP) 2015-114007

(51) Int. Cl. H04W 28/02; H04L 12/26

(52) U.S. Cl. CPC H04W 28/0215; H04L 43/0864; H04W 28/0236

(57) ABSTRACT

A congestion control device determines whether congestion occurs in a base station when a mobile terminal device connected to a mobile communication network communicates with a content delivery device through the base station. The congestion control device is installed in a proxy server device relaying communications between the base station and the content delivery device. The congestion control device includes a congestion condition table for registering congestion condition information, representing measurement results of communication received or transmitted by the mobile communication terminal through the base station. Upon acquiring the identification of the base station communicating with the mobile terminal device, the congestion control device reads the congestion condition information correlated to the identification of the base station from the congestion condition table, thus determining whether congestion occurs in the base station.

### TECHNICAL FIELD

The present invention relates to a local congestion determination method and a congestion control device for mobile communications.

The present application claims the benefit of priority on Japanese Patent Application No. 2015-114007 filed on Jun. 4, 2015, the subject matter of which is hereby incorporated herein by reference.

### BACKGROUND ART

Recently, communication traffic has been increased so as to cause congestion in networks due to spreading of mobile terminal devices such as mobile phones and smartphones. For example, local communication traffic exceeding wireless bands of base stations may occur at event venues undergoing concentration of communications. In this case, congestion occurs in networks connected between mobile terminal devices and base stations, and therefore part of mobile terminal devices may become unable to communicate with their counterpart devices. Thus, engineers have developed various technologies for determining or controlling congestion in networks.

Patent Literature 1 discloses a compression instruction device for instructing compression of contents being delivered through communication devices undergoing congestion. When a content delivery device delivers contents to a radio terminal through a radio base station, the compression instruction device determines a. congestion condition in the radio base station so as to instruct the content delivery device to compress its contents. The compression instruction device picks up communication data by use of a probe device configured to intercept communication passing through the radio base station; it measures the amount of packets, the amount of retransmitted packets, and delay times for receiving packets included in tapped data; thus, it determines the degree of congestion based on the measurement results. The compression instruction device determines the presence/absence of congestion for each radio base station connected to the radio terminal, and therefore it applies a compression process to communication between nodes which are determined to be congested.

Patent Literature 2 discloses a traffic congestion estimation method for a wireless local area network (i.e. a wireless LAN). In a system for connecting an access point to terminal devices in a wireless LAN, a centrally-associated server device determines which terminal device should be connected to the access point based on an index representing congestion and an index representing the condition of each channel between each terminal device and the access point. Herein, the centrally-associated server device derives a transmission rate from an index representing the condition of each channel, and therefore it determines which terminal device should be connected to the access point based on a combination of the transmission rate and an index representing a congestion condition that is set using an average round trip time (RTT).

Patent Literature 3 discloses a communication device realizing priority control in an uplink direction or a downlink direction by autonomously controlling mobile stations, Herein, it calculates the number of lost packets based on the round trip time (RTT); it calculates the number of disappeared packets for each radio interval by subtracting the number of discarded packets from the number of lost packets; thus, it determines the occurrence of congestion based on the number of disappeared packets. Patent Literature 4 discloses a communication control system that can efficiently carry out communication while preventing useless traffic due to congestion by carrying out congestion control in real time irrespective of an increased network utilization rate. Patent Literature 5 discloses a congestion control device interposed between the Internet and an intra-network of an Internet provider. The congestion control device determines the congestion conditions in networks destined to a Web server based on the TCP/IP conditions such as the window size, the packet discard rate, the response time, and the throughput.

### CITATION LIST

### Patent Literature

Patent Literature 1: Japanese Patent Application Publication No. 2014-241552

Patent Literature 2: Japanese Patent Application Publication No. 2014-192899

Patent Literature 3: Japanese Patent Application Publication No. 2010-219802

Patent Literature 4: Japanese Patent Application Publication No. 2009-111562

Patent Literature 5: Japanese Patent Application Publication No. 2003-163698

SUMMARY OF INVENTION

### Technical Problem

The technology of Patent Literature 1 is designed to set a criterion for determining congestion for each wireless terminal, and therefore it employs a determination criterion as the congestion condition being obtained when a radio terminal accesses a radio base station. For this reason, the compression instruction device cannot determine congestion and instruct compression of contents unless the radio terminal does not access the radio base station one or more times: this may raise a problem that the content delivery cannot be optimized in the first-time access. In addition, the technology of Patent Literature 1 needs to provide a probe device configured to collect congestion conditions of radio base stations, but it takes time and labor to introduce the probe device. Moreover, it is necessary to monitor all the packets passing through radio base stations, and therefore high performance should be required for the probe device. That is, no technology has been developed to determine congestion in the first-time access without additionally providing any device such as the probe device for detecting congestion in networks. In this connection, the technology of Patent Literature 2 is irrelevant to the determination of congestion in each base station.

The present invention is made in consideration of the aforementioned circumstances, and therefore the present invention aims to provide a local congestion determination method and a congestion control device for mobile communications.

### Solution to Problem

A first aspect of the present invention is directed to a congestion control device including a congestion condition table for storing congestion condition information representing measurement results of communication received or transmitted by a mobile terminal device connected to a mobile communication network through a base station in connection with a communication identification of the mobile terminal device and an identification of the base station; and a congestion determination part for reading the congestion condition information correlated to the identification of the base station from the congestion condition table upon retrieving the identification of the base station communicating with the mobile terminal device, thus determining whether congestion occurs in the base station.

A second aspect of the present invention is directed to a communication system including at least one mobile terminal device connected to a mobile communication network; a base station connected to the at least one mobile terminal device; a content delivery device configured to deliver content data to the at least one mobile terminal device; and a communication relay device configured to relay and transmit the content data delivered from the content delivery device to the base station. Herein, the aforementioned congestion control device is installed in the communication relay device.

A third aspect of the present invention is directed to a communication relay device, suited to the situation that a mobile terminal device connected to a mobile communication network communicates with a content delivery device through a base station, which relays and transmits content data delivered from the content delivery device to the base station. Herein, the aforementioned congestion control device is installed in the communication relay device.

A third aspect of the present invention is directed to a congestion determination method including the steps of: registering congestion condition information, representing measurement results of communication received or transmitted by a mobile terminal device connected to a mobile communication network though a base station in a congestion condition table in connection with a communication identification of the mobile terminal device and an identification of the base station; acquiring the identification of the base station communicating with the mobile terminal device; reading the congestion condition information correlated to the identification of the base station from the congestion condition table; and thereby determining whether congestion occurs in the base station.

A fourth aspect of the present invention is directed to a program causing a computer to implement: a registration process for registering congestion condition information, representing measurement results of communication received or transmitted. by a mobile terminal device connected to a mobile communication network through a base station, in a congestion condition table; a base station information retrieval process for retrieving an identification of the base station communicating with the mobile terminal device; and a congestion determination process for reading the congestion condition information correlated to the identification of the base station from the congestion condition table and thereby determining whether congestion occurs in the base station.

### Advantageous Effects of Invention

The present invention is applied to a communication system including a mobile terminal device connected to mobile communication networks, a base station connected to the mobile terminal device, a content delivery device (e.g. a Web server device) for delivering contents to the mobile terminal device, and a communication relay device (e.g. a proxy server device) for relaying and transmitting content data, delivered by the content delivery device, to the base station. In particular, a congestion control device installed in the communication relay device determines the occurrence of congestion in the base station and/or the mobile terminal device, and therefore it clears up congestion by compressing content data. Herein, the congestion control device measures the round trip time (RTT) between a request and a response in the mobile terminal device, and therefore it stores the congestion condition information, correlating the communication identification of the mobile terminal device and the identification of the base station, on a congestion condition table. Thus, it is possible for the congestion control device to easily determine whether or not congestion occurs between the base station and the mobile terminal device with reference to the congestion control table.

### BRIEF DESCRIPTION OF DRAWINGS

FIG. 1 is a block diagram showing a minimum configuration of a congestion control device according to one embodiment of the present invention.

FIG. 2 is a block diagram of a communication system in which the congestion control device according to one embodiment of the present invention is applied to a proxy server device.

FIG. 3 is a block diagram of the congestion control device according to one embodiment of the present invention.

FIG. 4 shows examples of congestion condition tables stored in the congestion control device according to one embodiment of the present invention.

FIG. 5 is a sequence diagram showing a congestion control process that is executed while contents from a Web server device are delivered through a proxy server device in response to a request of a mobile terminal device.

FIG. 6 is a sequence diagram showing a registration process of congestion control tables that is executed by the congestion control device after delivering contents to the mobile terminal device through the proxy server device.

FIG. 7 is a flowchart showing a congestion determination process that is executed by a congestion determination part of the congestion control device with reference to congestion condition tables.

### DESCRIPTION OF EMBODIMENTS

A local congestion determination method and a congestion control device for mobile communications according to the present invention will be describe in detail by way of embodiments with reference to the accompanying drawings.

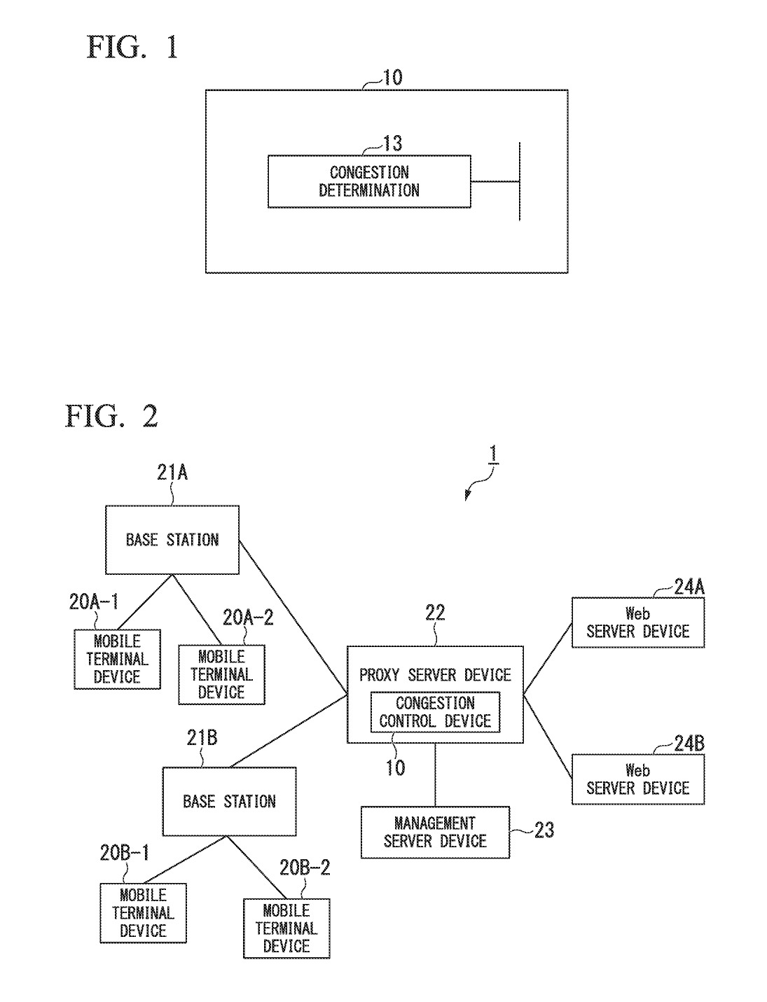

FIG. 1 is a block diagram showing the minimum configuration of a congestion control device 10 according to one embodiment of the present invention. The congestion control device 10 includes at least a congestion determination part 13. The congestion determination part 13 acquires an identification of a base station communicating with a terminal device, subjected to congestion determination, connected to a mobile communication network; it retrieves congestion condition information correlated to the identification of a base station from a congestion condition table; and then it determines whether or not congestion occurs in the base station based on the congestion condition information.

FIG. 2 is a block diagram of a communication system 1 adopting the congestion control device 10 according to one embodiment of the present invention. The communication system 1 includes base stations 21A, 21B, a proxy server device 22, a management server device 23, and Web server devices 24A, 24B. The base station 21A is able to communicate with mobile terminal devices 20A-1, 20A-2 while the base station 21B is able to communicate with mobile terminal devices 20B-1, 20B-2. In this connection, the mobile terminal devices 20A-1, 20A-2, 209-1, and 20B-2 will be collectively referred to as mobile terminal devices 20. The base stations 21A and 213 will be collectively referred to as base stations 21. The Web server devices 24A and 24B will be collectively referred to as Web server devices 24.

The mobile terminal device 20 is a mobile station such as a smartphone used for mobile communication. The base station 21 is a radio base station installed in a mobile communication network. The Web server device 24 is a content delivery server device configured to deliver contents such as moving pictures, still pictures, and text data to the mobile terminal device 20. The proxy server device 22 substituting for two Web server devices 24 is a communication relay device configured to relay communication with the base station 21. The management server device 23 stores a data table representing the correlation between an IP address (i.e. a communication identification) of the mobile terminal device 20 and an identification of the base station 21 communicating with the mobile terminal device 20. When the mobile terminal device 20 is moved and located in a service area of another base station 21, the management server device 23 updates the content of a data table. For example, the Web server device 24 and the proxy server device 22 are provided in a WAN (Wide Area Network) such as the Internet, and therefore they can communicate with each other. In addition, the proxy server device 22 and the management server device 23 are connected to a LAN (Local Area Network).

Both the mobile communication network for setting up the base station 21 and the Internet for setting up the proxy server device 22 are connected together through a gateway device (not shown). When the mobile terminal device 20A-1 accesses the Web server device 24A, for example, the mobile terminal device 20A-1 sends an HTTP request to the base station 21A. The HTTP request is transmitted to the proxy sever device 22 located in the Internet by way of a communication control system (not shown) located in the mobile communication network. Then, the proxy server device 22 transfers the HTTP request to the Web server device 24A. The Web server device 24A generates an HTTP response to the HTTP request so as to transfer the HTTP response to the proxy server device 22. Thereafter, the proxy server device 22 transmits the HTTP response to the base station 21A, which in turn transmits the HTTP response to the mobile terminal device 20A-1. When the mobile terminal device 20A-1 transmits the HTTP request to the Web server device 24A again, the Web server device 24A transmits the HTTP response to the mobile terminal device 20A-1 through the proxy server device 22.

In the communication system 1, the amount of communication conducted between the proxy server device 22 and the Web server device 24 can be suppressed using the function of the proxy server device 22. However, it is impossible to suppress the amount of communication conducted between the mobile terminal device 20 and the proxy server device 22. Therefore, when the mobile terminal device 20 accesses the Web server device 24 simultaneously delivering contents, there is a possibility that congestion may occur due to insufficient network bands. The occurrence of congestion in networks may reduce QoE (Quality of Experience) for a user viewing contents with the mobile terminal device 20. To prevent a reduction of QoE, the present embodiment applies the congestion control device 10 to the proxy server device 22 so as to suppress congestion occurring in networks.

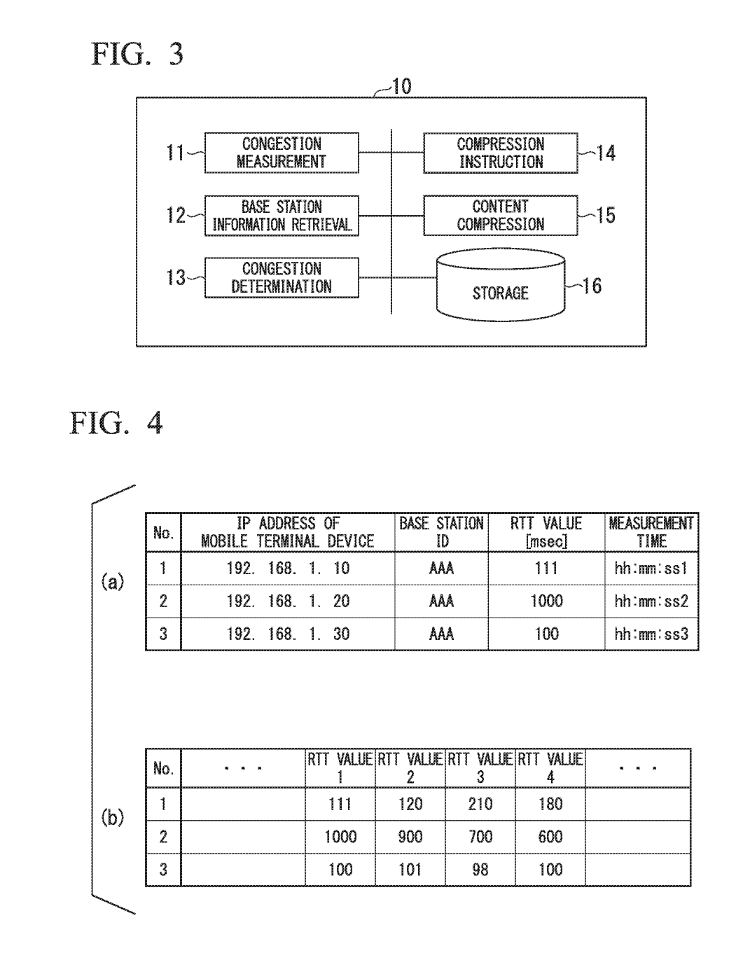

FIG. 3 is a block diagram of the congestion control device 10 according to one embodiment of the present invention. The congestion control device 10 includes a congestion measurement part 11, a base station information retrieval part 12, a congestion determination part 13, a compression instruction part 14, a content compression part 15, and a storage unit 16. The congestion measurement part 11 measures the time round trip time) counting from the timing to transmit a request to the timing to receive a response by the mobile terminal device 20 based on the flag information ACK flag) received or transmitted according to a communication procedure (e.g. TCP) applied to communication conducted between the mobile terminal device 20 and the proxy server device 22. The round trip time (RTT) represents a congestion condition of networks. The congestion measurement part 11 stores the correlation between the round trip time (RTT), the communication identification of the mobile terminal device 20, and the identification of the base station 21 retrieved by the base station information retrieval part 12 on a congestion condition table. The congestion condition table is stored on the storage unit 16. The base station information retrieval part 12 retrieves the identification of the base station 21 communicating with the mobile terminal device 20 with reference to the data table representing the correlation between the mobile terminal device 20 and the base station 21 based on the communication identification of the mobile terminal device 20 subjected to RTT measurement.

As described above in conjunction with FIG. 1. the congestion determination part 13 determines whether congestion occurs in the base station 21. Upon determining that congestion does not occur in the base station 21, the congestion determination part 13 determines whether congestion occurs in communication conducted between the mobile terminal device 20 and the proxy server device 22. The compression instruction part 14 instructs the content compression part 15 to compress content data delivered through the base station 21 when the congestion determination part 13 determines that congestion occurs in the base station 21. In contrast, the compression instruction part 14 instructs the content compression part 15 to compress content data delivered to the mobile terminal device 20 when the congestion determination part 13 determines that congestion does not occur in the base station 21 but it determines that congestion occur in communication with the mobile terminal device 20. The content compression part 15 carries out a compression process for content data according to an instruction of the compression instruction part 14.

FIG. 4 shows examples of congestion condition tables stored on the storage unit 16 of the congestion control device 10. The congestion condition table has records relating to the history of information concerning congestion conditions measured by the congestion measurement part 11. FIG. 4(a) shows an example of a congestion condition table having items entitled “No”, “IP ADDRESS OF MOBILE TERMINAL DEVICE”, “BASE STATION ID”, “RTT VALUE”, and “MEASUREMENT TIME”. The item “No” registers identifications applied to RTT measurement performed by the congestion measurement part 11. The item “IP ADDRESS OF MOBILE TERMINAL DEVICE” registers the IP address (i.e. the communication identification) of the mobile terminal device 20 subjected to RTT measurement. The item “BASE STATION ID” registers the identification of the base station 21 communicating with the mobile terminal device 20 subjected to RTT measurement. The item “RTT VALUE” registers the round trip time (RTT) measured by the congestion measurement part 11. The item “MEASUREMENT TIME” registers the time that the congestion measurement part 11 measures RTT values.

The congestion measurement part 11 retrieves an IP address of the mobile terminal device 20 included in the header of a packet corresponding to an HTTP response to an HTTP request made by the mobile terminal device 20 subjected to RTT measurement, thus registering the IP address in “IP ADDRESS OF MOBILE TERMINAL DEVICE” of the congestion condition table. In addition, the congestion measurement part 11 inquires the management server device 23 about the status as to which base station 21 the mobile terminal device 20 specified by the IP address is communicating with, and therefore the congestion measurement part 11 registers the identification of the base station 21 described in a response from the management server device 23 in “ID OF BASE STATION” of the congestion condition table. Moreover, the congestion measurement part 11 measures the time (i. e. RTT) counting from the timing that the proxy server device 22 transmits a packet including an FIN/ACK flag to the mobile terminal device 20 to the timing of receiving a last packet including an ACK flag in response to the transmitted packet by way of a series of HTTP responses to an HTTP request made by the mobile terminal device 20 subjected to RTT measurement, For example, it is possible to obtain RTT by executing a system call for obtaining RTT. Alternatively, it is possible to measure a RTT value by calculating a time difference between the timing of transmitting a packet including an FIN; ACK flag and the timing of receiving a packet including an ACK flag. The congestion measurement part 11 registers the RTT value in “RTT VALUE” of the congestion condition table. In addition, the congestion measurement part 11 registers the RTT measurement time in “MEASUREMENT TIME” of the congestion control table.

Every time an HTTP request is transmitted by the mobile terminal device 20 subjected to RTT measurement, the congestion measurement part 11 carries out RTT measurement for each HTTP response to the HTTP request, and therefore the measurement result is added as one record to the congestion condition table. The congestion measurement part 13 determines whether congestion currently occurs in the base station 21 communicating with the mobile terminal device 20 with reference to records which are registered in a predetermined period of time retrogressing from the congestion determination time within the registered information of the congestion condition table. In this connection, it is possible to add another “VALID TIME” in the congestion condition table. The congestion measurement part 11 may register the time which elapses from the RTT measurement time by a predetermined time in “VALID TIME” of the congestion condition table. In this case, the congestion determination part 13 may determine congestion with reference to only the records having values of “VALID TIME” registered after the current time in the congestion condition table.

FIG. 4(b) shows another example of a layout of items described in a congestion condition table. FIG. 4(b) does not describe the foregoing items shown in FIG. 4(a), i.e. “IP ADDRESS OF MOBILE TERMINAL DEVICE”, “BASE STATION ID”, and “MEASUREMENT TIME”. The congestion condition table of FIG. 4(b) differs from the congestion condition table of FIG. 4(a) in that it provides items “RTT VALUE 1”, “RTT VALUE 2”, “RTT VALUE 3”, and “RTT VALUE 4” for registering multiple RTT values. When accessing a Web page including multiple images, for example, an HTTP response concerning text data of the Web page as well as HTTP responses concerning multiple image data are replied in response to a single HTTP request transmitted by the mobile terminal device 20. In this case, the congestion measurement part 11 carries out RTT measurement for multiple HTTP responses, thus obtaining multiple RTT values. That is, the congestion measurement part 11 registers multiple RTT values, which are measured with respect to multiple HTTP responses, as records of “RTT VALUE 1”, “RTT VALUE 2”, “RTT VALUE 3”, and “RTT VALUE 4” in the congestion condition table. Alternatively, the congestion measurement part 11 may carry out RTT measurement for each unit time (e.g. 10 seconds) so as to obtain multiple RTT values, thus registering them as records of “RTT VALUE 1”, “RTT VALUE 2”, “RTT VALUE 3”, and “RTT VALUE 4” in the congestion condition table. As RTT measurement for each unit time, for example, the congestion measurement part 11 may measure RTT values with respect to all the HTTP responses so as to classify their measurement times for each unit time. When multiple RTT values are measured in each unit time, it is possible to select a representative value (e.g. an average value, a central value, a firstly-measured value, etc.) among multiple RTT values, thus registering the representative value in the congestion condition table. By using the congestion condition table registering multiple TUT values, it is possible for the congestion determination part to determine congestion conditions in more detail.

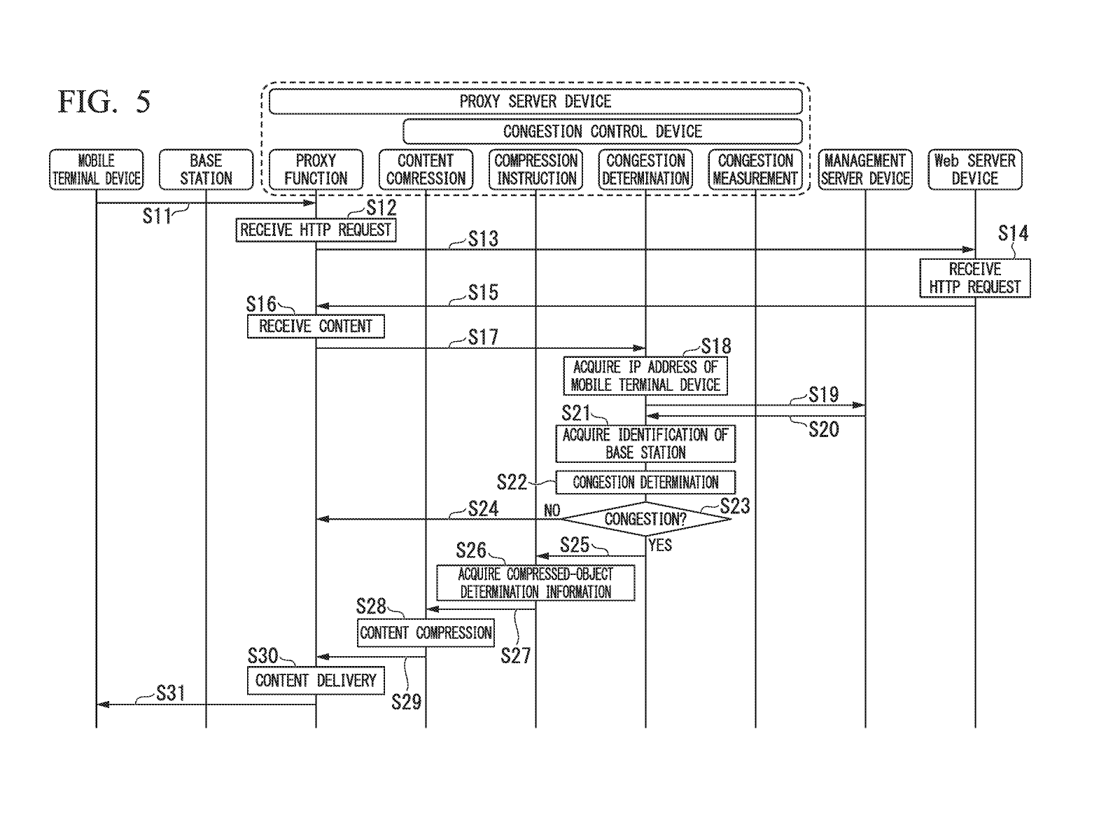

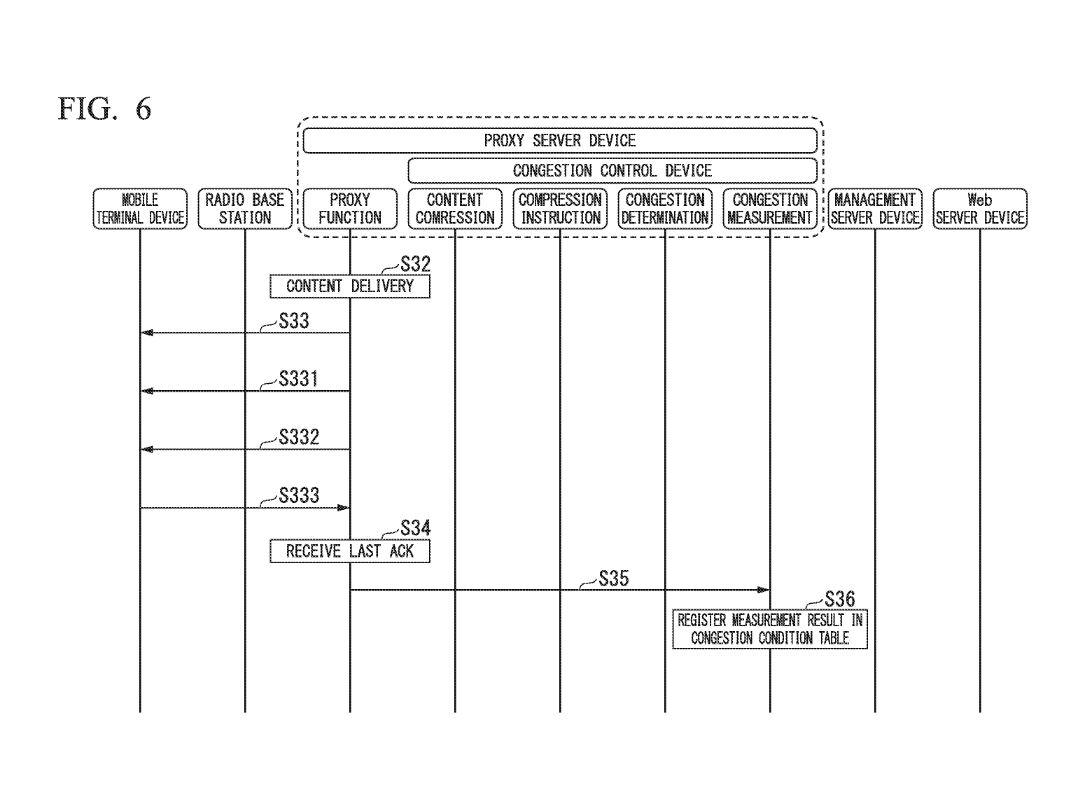

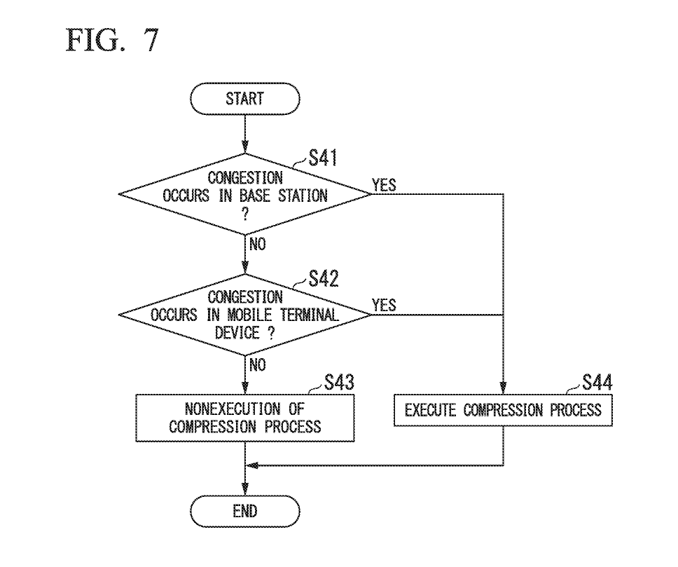

As described above, the congestion determination part 13 determines congestion in the base station 21 by use of the congestion condition table, and therefore the congestion control device 10 carries out a congestion control process for suppressing congestion based on determination results. FIG. 5 shows a sequence diagram for a congestion control process; FIG. 6 shows a sequence diagram for a registration process for the congestion condition table; and FIG. 7 shows a flowchart for the congestion control process.

FIG. 5 shows the congestion control process to be executed before delivering contents through the proxy server device 22 from the Web server device 24 in response to a request of the mobile terminal device 20. First, the mobile terminal device 20 transmits an HTTP request for requesting delivery of contents by the Web server device 24 (step S11). Subsequently, the proxy server device 22 receives the HTTP request (step S12). The HTTP request is transferred to the Web server device 24 by way of the function of the proxy server device 22 (step S13). Thus, the Web server device 24 receives the HTTP request (step S14). Thereafter, the Web server device 24 transmits content data (i.e. an HTTP response) requested by the HTTP request to the proxy server device 22 (step S15). Thus, the proxy server device 22 receives the HTTP response (step S16).

Next, the proxy server device 22 requests the congestion control device 10 to determine congestion (step S17). In the congestion control device 10, the congestion determination part 13 acquires an IP address of the mobile terminal device 20 serving as a destination for sending the HTTP response (step S18). For example, the proxy server device 22 retrieves the IP address of the mobile terminal device 20 from a packet of the HTTP request so as to temporarily store it therein; hence, the congestion determination part 13 is able to obtain the IP address. Thereafter, the congestion determination part 13 inquires the management server device 23 about the status as to which base station 21 the mobile terminal device 20 specified by the IP address is communicating with (step S19). The management server device 23 provides a data table showing the correlation between the base station 21 and the mobile terminal device 20, which are connected to each other. Thus, the management server device 23 reads an identification of the base station 21 connected to the mobile terminal device 20 specified by the IP address acquired by the congestion determination part 13. The management server device 23 transmits to the congestion control device 10 the identification of the base station 21 connected to the mobile terminal device 20 (step S20). In the congestion control device 10, the congestion determination part 13 obtains the identification of the base station 21 (step S21). Thereafter, the congestion determination part 13 determines congestion with reference to the congestion condition table shown in FIG. 4 based on the IP address of the mobile terminal device 20 and the identification of the base station 21 (step S22).

Next, the congestion determination process will be described with reference to the flowchart of FIG. 7. First, the congestion determination part 13 determines whether congestion occurs in the base station 21 (step S41). Specifically, the congestion determination part 13 reads from the congestion condition table of FIG. 4 all the records concerning the base station 21 (i.e. records each having the value of “BASE STATION ID” identical to the identification of the base station 21) within a predetermined range of elapsed times each counting from the time registered as “MEASUREMENT TIME” to the current time based on the identification of the base station 21 retrieved from the management server device 23. Thereafter, the congestion determination part 13 determines the representative value of “RTT VALUE” among all records read from the congestion condition table. As the representative value, for example, it is possible to mention an average value and a central value. Alternatively, it is possible to calculate the representative value among RTT values by applying weights to RTT values depending on elapsed times counting from the RTT measurement time. The congestion determination part 13 compares the representative value among RTT values with a predetermined first threshold. Herein, when “representative value among RTT values” (first threshold), the congestion determination part 13 determines that congestion occurs in the base station 21.

In this connection, it is possible to determine congestion in the base station 21 by use of another parameter ascribed to the base station 21 other than the representative value among RTT values. For example, the congestion determination part 13 determines congestion with respect to each of mobile terminal devices 20 connected to the base station 21, and therefore it may determine that congestion occurs in the base station 21 when congestion occurs in all the mobile terminal devices 20 (e.g. when the representative value among RTT values registered for the mobile terminal devices 20 is equal to or greater than the first threshold value). Alternatively, the congestion determination part 13 may determine that congestion occurs in the base station 21 when the ratio of the mobile terminal devices 20 undergoing congestion the mobile terminal devices 20 relating to the representative value of RTT values equal to or greater than the first threshold) is equal to or greater than a predetermined second threshold (e.g. a half the number of the mobile terminal devices 20 connected to the base station 21).

When it is determined that congestion occurs in the base station 21 (i.e. the determination result “YES” in step S41), the compression instruction part 14 determines to execute a compression process for content data being delivered through the base station 21 (step S44). On the other hand, when it is determined that congestion does not occur in the base station 21 (i.e. the determination result “NO” in step S41), the congestion determination part 13 determines whether congestion occurs in the mobile terminal device 20 connected to the base station 21 (step S42). Specifically, the congestion determination part 13 extracts records each having the value of “IP ADDRESS OF MOBILE TERMINAL DEVICE” identical to the IP address of the mobile terminal device 20, which is retrieved from the proxy server device 22, among the records read from the congestion condition table in step S41. Thereafter, the congestion determination part 13 calculates the representative value among RTT values with respect to the extracted records. As the representative value, for example, it is possible to mention an average value and a central value. The congestion determination part 13 compares the representative values of RTT values ascribed to the mobile terminal device 20 with a predetermined threshold (e.g. the first threshold). Herein, when (representative value of RTT values of mobile terminal device 20)≥(predetermined threshold), the congestion determination part 13 determines that congestion occurs in the mobile terminal device 20. When it is determined that congestion occurs in the mobile terminal device 20 (i.e. the determination result “YES” in step S42), the compression instruction part 14 determines to execute a compression process for content data being delivered to the mobile terminal device 20 (step S44). On the other hand, when it is determined that congestion does not occur in the mobile terminal device 20 (i.e. the determination result “NO” in step S44 the compression instruction part 14 determines not to execute a compression process for content data being delivered to the mobile terminal device 20 through the base station 21 (step S43). In this case, the proxy server device 22 delivers original content data to the mobile terminal device 20 through the base station 21 without carrying out a. compression process for original content data being transmitted from the Web server device 24.

Next, a concrete example of the congestion determination process will be described. For example, the following description refers to “192.168.1.20” as an IP address of the mobile terminal device 20 obtained in step S18 and “BASE STATION ID=AAA” as an identification of the base station 21 obtained in step S21. When the RRT value of the mobile terminal device 20 is equal to or greater than 500 ms (i.e. the first threshold) serving as a determination criterion of the congestion condition, the congestion determination part 13 determines that congestion occurs in the mobile terminal device 20. In addition, the congestion determination part 13 determines that congestion occurs in the base station 21 when congestion occurs in all the mobile terminal devices 20 connected to the same base station 21. In this connection, the congestion control device 10 has stored the congestion condition table shown in FIG. 4(a). The congestion condition table shows that three mobile terminal devices 20 corresponding to No. 1 through No. 3 records are connected to the base station 21 (i.e. BASE STATION ID=AAA). Herein, No. 2 mobile terminal device 20 (i.e. IP ADDRESS: 192.168.1.20) among No. 1 through No. 3 mobile terminal devices 20 has the RRT value of 1,000 ms (≥500 ms); hence, it is determined that congestion occurs in the mobile terminal device 20. That is, the congestion determination part 13 determines that congestion does not occur in the base station 21 since congestion occurs in only one mobile terminal device 20 among three mobile terminal devices 20 connected to the base station 21 (i.e. BASE STATION ID=AAA). On the other hand, the congestion determination part 13 determines that congestion occurs in No. 2 mobile terminal device 20. According to the aforementioned results of determination, the compression instruction part 14 determines to carry out a compression process for content data being delivered to No. 2 mobile terminal device 20.

Referring back to FIG. 5, its sequence diagram will be descried below. The congestion determination part 13 stores the results of congestion determination made by the congestion determination part 13 in step S22 on the storage unit 16 in connection with their determination times. The congestion determination part 13 sends the information representing “no congestion” to the proxy server device 22 (step S24) when it determines that congestion does not occur in the base station 21 and the mobile terminal device 20 (i.e. the determination result “NO” in step S23). The content data transmitted from the Web server device 24 are directly delivered to the mobile terminal device 20 by way of the function of the proxy server device 22 (step S30). Thereafter, the content data are delivered to the mobile terminal device 20 making an HTTP request through the base station 21 (step S31).

When the result of determination in step S22 indicates that congestion occurs in the base station 21 or the mobile terminal device 20 (i.e. the determination result “YES” of step S23), the congestion determination part 13 sends to the compression instruction part 14 the information representing “occurrence of congestion” and the information indicating an compression-process applied object either the base station 21 or the mobile terminal device 20 (hereinafter, referred to as “compressed-object determination information”) (step S25). The compression instruction part 14 obtains the compressed-object determination information (step S26) and instructs the content compression part 15 to carry out a compression process for contents (step S27). When the compressed-object determination information describes that congestion occurs in the base station 21, for example, the compression instruction part 14 instructs the content compression part 15 to carry out a compression process for all the content data being delivered through the base station 21 in a predetermined period of time (e.g. some seconds) counting from the congestion determination time registered by the congestion determination part 13. Thus, it is possible to omit a series of processes (i.e. steps S17 through S23) in response to HTTP requests made by multiple mobile terminal devices 20, and therefore it is possible to reduce the burden of processing of the congestion control device 10.

Upon being instructed to carry out a compression process for contents by the compression instruction part 14, the content compression part 15 selects content data subjected to compression based on the compressed-object determination information describing either the identification of the base station 21 or the IP address of the mobile terminal device 20, thus carrying out a compression process for the selected content data (step S28). For example, the content compression part 15 carries out a process for increasing the compression rate of JPEG still-picture data or a process for reducing the hit rate of H.264 moving-picture data. In this connection, the content compression part 15 can select desired content data since content data are correlated to the identification of the base station 21 and/or the IP address of the mobile terminal device 20 by way of the function of the proxy server device 22. The content compression part 15 sends the compressed content data to the proxy server device 22 (step S29). The proxy server device 22 executes a delivery process for the content data compressed by the content compression part 15 (step S30). The compressed content data are delivered to the mobile terminal device 20 making an HTTP request through the base station 21 (step S31).

According to the aforementioned processes, it is possible to determine whether or not congestion occurs in the base station 21 or the mobile terminal device 20. The congestion control device 10 can alleviate congestion by compressing content data when congestion occurs in either the base station 21 or the mobile terminal device 20. Thus, it is possible to prevent a reduction of user's QoE.

FIG. 6 is a sequence diagram showing a registration process for a congestion condition table which is carried out by the congestion control device 10 after delivering contents to the mobile terminal device 20 through the proxy server device 22. First, the proxy server device 22 carries out a delivery process for content data compressed by the content compression part 15 (step S32). Normally, content data are divided into multiple packets and then delivered to their destinations of delivery. For this reason, a plurality of compressed content data are delivered to the mobile terminal device 20 making an HTTP request through the base station 21 (steps S33, S331, S332). Upon completion of the delivery process for content data from the proxy server device 22 to the mobile terminal device 20, the mobile terminal device 20 sends back a packet including a FIN flag to the proxy server device 22, and then the proxy server device 22 transmits a packet including an ACK flag and a FIN flag to the mobile terminal device 20. Upon receiving the packet including the ACK flag and the FIN flag, the mobile terminal device 20 transmits a packet including an ACK flag to the proxy server device 22 at last (step S333). The proxy server device 22 receives the last packet including the ACK flag (step S34). Thus, it is possible to complete a series of HTTP responses to an HTTP request made by the mobile terminal device 20.

Upon receiving the last packet including the ACK flag, the proxy server device 22 notifies the congestion measurement part 11 of the reception of the last packet (step S35). The congestion measurement part 11 carries out RTT measurement triggered by a system call. Specifically, the congestion measurement part 11 makes an inquiry to the management server device 23 by use of the IP address of the mobile terminal device 20 included in the received packet, thus acquiring the identification of the base station 21 connected to the mobile terminal device 20. The congestion measurement part 11 adds the records describing the IP address of the mobile terminal device 20, the identification of the base station 21, the RTT measured values, and the measurement times to the congestion condition table.

Thus, it is possible for the congestion control device 10 to collect any information required for congestion determination. According to the RTT measurement method of the present embodiment, it is possible to measure RTT values by use of predetermined flags applied to essential communication procedures set up by communication protocols such as TCP. In addition, it is possible to measure RTT values in response to a system call normally furnished with any OS (Operating System) working on the congestion control device 10; this may eliminate the necessity of additionally providing a probe device or a probe function employed by the conventional technology. Moreover, the present embodiment requires WIT measurement to be carried out once in response to a single HTTP response. Compared with the conventional method for checking all the packets passing through the base station 21, it is possible for the present embodiment to reduce the burden of processing.

The present embodiment carries out RTT measurement based on HTTP responses transferred from the proxy server device 22 to the mobile terminal device 20 so as to determine congestion occurring in the base station 21 connected to the mobile terminal device 20. Therefore, it is possible to determine congestion even in the first-time access made by the mobile terminal device 20 through the base station 21 in the situation that congestion occurs locally in the base station 21 at any event venue. In addition, it is possible to appropriately carry out a compression process for content data depending on the situation. In the communication system of FIG. 2, for example, handover may be carried out such that the mobile terminal device 20A-1 connected to the base station 214 is moved to the areas of the base station 21B, and then the mobile terminal device 20A-1 should make a first-time access through the base station 21B. In this case, it is possible to determine whether congestion occurs in the base station 21B based on the results of RTT measurement relating to the mobile terminal devices 20B-1 and 20B-2 connected to the base station 21B. When it is determined that congestion occurs in the base station 21B, it is possible to deliver the compressed contents to the mobile terminal device 20A-1 through the base station 21B at the first-time access made by the mobile terminal device 20A-1. Thus, it is possible to prevent a reduction of QoE in view of the user of the mobile terminal device 20A-1.

The present embodiment is designed to carry out RTT measurement using packets being transmitted or received between a delivery source and a delivery destination of content data and thereby carry out a compression process for packets being transmitted to the delivery destination, and therefore the congestion control device 10 is installed in the proxy server device 22; but this is not a restriction. That is, it is possible to install the congestion control device 10 in any communication relay device other than the proxy server device 22.

The congestion control device 10 has a computer system therein. The foregoing processes of the congestion control device 10 are stored as programs on computer-readable storage media. That is, it is possible to implement the foregoing processes of the congestion control device 10 by means of a computer that reads programs from storage media so as to execute programs. Herein, computer-readable storage media refers to magnetic disks, magneto-optical disks, CD-ROM, DVD-ROM, semiconductor memory, etc. In addition, it is possible to deliver programs to a computer through communication lines, and therefore the computer may execute programs.

The foregoing programs may achieve part of the functionality of the congestion control device 10. Alternatively, the foregoing programs may be so-called differential files (or differential programs) which can be combined with pre-installed programs of a computer system so as to achieve the functionality of the congestion control device 10.

The local congestion determination method and the congestion control device for mobile communications according to the present invention have been described above; but the present invention is not necessarily limited to the foregoing embodiment. That is, the present invention may embrace any design change or any modification for replacing the foregoing constituent elements with other constituent elements within the scope of the invention as defined in the appended claims. For example, the proxy server device 2 and the Web server device 24 need to be connected to mobile communication networks; hence, they should not be necessarily located on the Internet.

### INDUSTRIAL APPLICABILITY

The present invention relates to the local congestion determination method and the congestion control device for mobile communications; but its applied fields should not be limited to mobile communications; hence, the present invention is applicable to other types of communication methods. In addition, the present invention is not necessarily limited to delivery of contents from Web server devices; hence, the present invention is applicable to data communication between information processing devices.

### REFERENCE SIGNS LIST

1 communication system

10 congestion control device

11 congestion measurement part

12 base station information retrieval part

13 congestion determination part

14 compression instruction part

15 content compression part

16 storage unit

20 mobile terminal device

21 base station

22 proxy server device

23 management server device

24 Web server device

1. A congestion control device comprising:
a congestion measurement part configured to register congestion condition information representing measurement results of communication received or transmitted by a mobile terminal device through a base station in a congestion condition table in connection with a communication identification of the mobile terminal device and an identification of the base station; and
a congestion determination part configured to read the congestion condition information correlated to the identification of the base station from the congestion condition table upon retrieving the identification of the base station communicating with the mobile terminal device, thus determining whether congestion occurs in the base station; and
a compression instruction part configured to instruct compression of content data being delivered to the mobile terminal device through the base station when the congestion determination part determines that congestion occurs in the base station.

2. (canceled)

3. The congestion control device according to claim 1, wherein the congestion condition information stored in the congestion condition table indicates a round trip time counting from a timing of transmitting a request by the mobile terminal device to a timing of receiving a response to the request.

4. The congestion control device according to claim 1, wherein the congestion determination part determines whether congestion occurs in the mobile terminal device by comparing a first threshold with the congestion condition information registered in the congestion condition table.

5. The congestion control device according to claim 4, wherein, when a plurality of mobile terminal devices are connected to the base station, the congestion determination part determines whether congestion occurs in each of the plurality of mobile terminal devices with reference to the congestion condition table, and wherein the congestion determination part determines whether congestion occurs in the base station by comparing a second threshold with a ratio of the mobile terminal devices undergoing congestion to the plurality of mobile terminal devices.

6. (canceled)

7. The congestion control device according to claim 4, wherein upon determining that congestion does not occur in the base station, the congestion determination part determines whether congestion occurs in the mobile terminal device by comparing a predetermined threshold with the congestion condition information relating to the mobile terminal device registered in the congestion condition table, and
wherein the compression instruction part instructs the compression of the content data being delivered to the mobile terminal device when the congestion determination part determines that congestion occurs in the mobile terminal device.

8. The congestion control device according to claim 1, comprising wherein the congestion measurement part generates the congestion condition information by measuring a time counting from a timing of transmitting a request by the mobile terminal device to a timing of receiving a response to the request by use of a flag applied to a communication procedure adapted to communications transmitted or received by the mobile terminal device through the base station, and wherein the congestion measurement part registers the congestion condition information in the congestion condition table in connection with the communication identification of the mobile terminal device and the identification of the base station.

9. A communication system comprising:
a mobile terminal device connected to a mobile communication network;
a base station connected to the mobile terminal device;
a content delivery device configured to deliver content data to the mobile terminal device; and
a communication relay device configured to relay and transmit the content data delivered from the content delivery device to the base station,
wherein the congestion control device according to claim 1 is installed in the communication relay device.

10. (canceled)

11. A congestion determination method comprising:
registering congestion condition information, representing measurement results of communication received or transmitted by a mobile terminal device though a base station in a congestion condition table in connection with a communication identification of the mobile terminal device and an identification of the base station; and
acquiring the identification of the base station communicating with the mobile terminal device, reading the congestion condition information correlated to the identification of the base station from the congestion condition table, and thereby determining whether congestion occurs in the base station; and
instructing compression of content data being delivered to the mobile terminal device through the base station when it is determined that congestion occurs in the base station.

12. A non-transitory computer-readable storage medium having stored a program causing a computer to implement the congestion determination method according to claim 11.
